(19) United States
(12) Patent Application Publication
(10) Pub. No.: US 2026/0176175 A1
(43) Pub. Date: Jun. 25, 2026

(54) WATERWAY SYSTEM AND CONTROL METHOD FOR MINERALIZATION WATER PURIFIER, AND MINERALIZATION WATER PURIFIER

(71) Applicant: Guangdong Lizi Technology Co., Ltd., Foshan (CN)

(72) Inventors: Xing Zhan, Foshan (CN); Guoxiang Chen, Foshan (CN); Yutai Huang, Foshan (CN); Wenbin Chen, Foshan (CN); Jiawei Chen, Foshan (CN); Yijie Hao, Foshan (CN); Mingyao Li, Foshan (CN)

(21) Appl. No.: 19/026,364

(22) Filed: Jan. 17, 2025

(30) Foreign Application Priority Data
Dec. 19, 2024 (CN) 202411884157.5

(51) Int. Cl. C02F 1/66; C02F 1/00

(52) U.S. Cl. CPC C02F 1/66; C02F 1/008; C02F 2201/005; C02F 2209/06; C02F 2209/10; C02F 2209/40

(57) ABSTRACT

A waterway system, a control method, and a mineralization water purifier are provided. The waterway system includes a first alkaline filter material, a second alkaline filter material, and an alkaline water path; an alkalinity of the first alkaline filter material is greater than an alkalinity of the second alkaline filter material; and the first alkaline filter material can be configured to inhibit the second alkaline filter material from releasing an alkaline substance, wherein in the alkaline water path, the first and the second alkaline filter material are sequentially arranged in a preset water flowing direction, and/or, the alkaline water path is provided with a filter material mounting cavity configured to simultaneously accommodate the first and the second alkaline filter materials. Compared with the prior art, the waterway system has the advantages that the stability of the waterway system can be improved, and the service life can be prolonged.

### CROSS REFERENCE TO RELATED APPLICATIONS

The present application claims the benefit of Chinese Patent Application No. 202411884157.5 filed on Dec. 19, 2024, the contents of which are incorporated herein by reference in their entirety.

### TECHNICAL FIELD

The present disclosure relates to the technical field of water treatment equipment, and in particular, to a waterway system and a control method for a mineralization water purifier, and a mineralization water purifier.

### BACKGROUND

With the improvement of productivity, people have increasingly high demands for the quality of life and convenience. Alkaline water is a kind of water with a pH value greater than 7. Drinking alkaline water in moderation can replenish water, improve microcirculation, and promote metabolism. Meanwhile, in a case of water and electrolyte disturbance, the alkaline water further has an improvement function. For example, drinking alkaline water can help replenish water after a person vomits heavily. In addition, the alkaline water can further help neutralize excessive stomach acid, protect the gastric mucosa, and reduce the possibility of a peptic ulcer. Therefore, mineralized water is widely favored by people as drinking water. Meanwhile, there is also a requirement for the alkaline water during production and experimentation.

At present, there are two common methods to prepare alkaline water. The first method is to manually mix an alkaline substance with water to form alkaline water with a suitable pH value. However, this method is very complicated, has a chemical knowledge threshold, and is inefficient. The second method is to add an alkaline filter material into a container with water, such as a water dispenser and a water purifier. Alkaline substances in the alkaline filter material can be dissolved into the water in the container, thereby changing the water into alkaline water. In the early stage of use, a large number of alkaline substances enter the water, causing the pH value of the alkaline water to easily become large during this period. In the later stage of use, the content of the alkaline substances in the alkaline filter material decreases. As a result, a small number of the alkaline substances enter the water, and the pH value of the alkaline water within this period of time is too low. The alkaline water with a low or high pH value cannot meet a water utilization demand, which greatly affects the usability of the alkaline filter material.

### SUMMARY

In view of this, the present disclosure provides a waterway system and a control method for a mineralization water purifier and a mineralization water purifier, which can maintain a pH value of alkaline water relatively stable and prolong a service life of an alkaline filter material.

To achieve the above technical problems, a technical solution used in the present disclosure is as follows: a waterway system for a mineralization water purifier includes a first alkaline filter material, a second alkaline filter material, and an alkaline water path, wherein an alkalinity of the first alkaline filter material is greater than an alkalinity of the second alkaline filter material; and the first alkaline filter material is configured to inhibit the second alkaline filter material from releasing an alkaline substance,
wherein in the alkaline water path, the first alkaline filter material and the second alkaline filter material are sequentially arranged in a preset water flowing direction, and/or, the alkaline water path is provided with a filter material mounting cavity configured to simultaneously accommodate the first alkaline filter material and the second alkaline filter material.

Optionally, wherein the waterway system includes a rear-mounted water inlet path, a purified water path, and a water outlet path; the rear-mounted water inlet path is connected to the purified water path and the alkaline water path; and one end of the purified water path away from the rear-mounted water inlet path and one end of the alkaline water path away from the rear-mounted water inlet path are both connected to the water outlet path.

Optionally, wherein the waterway system further includes a first flow divider valve; the first flow divider valve is connected to the rear-mounted water inlet path, the purified water path, and the alkaline water path.

Optionally, wherein the waterway system further includes a first flow valve and a second flow valve; the first flow valve is connected to the purified water path; and the second flow valve is connected to the alkaline water path.

Optionally, wherein the waterway system further includes a first water quality detection member and a controller; both the first water quality detection member and the first flow divider valve are connected to the controller.

Optionally, wherein the first water quality detection member is arranged at the water outlet path.

Optionally, wherein the first water quality detection member is arranged at the alkaline water path, and is located behind the first alkaline filter material and the second alkaline filter material in the preset water flowing direction.

Optionally, wherein the waterway system further includes a first flow detection member; the first flow detection member is arranged on at least one of the rear-mounted water inlet paths, the alkaline water path, and the purified water path; and the first flow detection member is connected to the controller.

Optionally, the waterway system further includes a second flow divider valve; the second flow divider valve is connected to the controller; and the second flow divider valve is connected into the alkaline water path and is located behind the first water quality detection member in the preset water flowing direction.

Optionally, wherein a first water drainage branch and a wastewater outlet are further arranged in the waterway system; one end of the first water drainage branch is connected to the second flow divider valve; and the other end of the first water drainage branch is connected to the wastewater outlet.

Optionally, wherein the waterway system further includes a second water quality detection member and a water purification assembly; an output end of the water purification assembly is connected to one end of the rear-mounted water inlet path away from the first flow divider valve; and the second water quality detection member is arranged in the rear-mounted water inlet path; and the second water quality detection member is connected to the controller.

Optionally, wherein the first water quality detection member and the second water quality detection member are at least one of a Total Dissolved Solids (TDS) value detection member and a pH value detection member.

Optionally, wherein a first backflow water path; the first backflow water path is connected to the water purification assembly.

Optionally, wherein the waterway system further includes a third flow divider valve; the third flow divider valve is connected to the purified water path and one end of the first backflow water path away from the water purification assembly.

Optionally, wherein the waterway system further includes a fourth flow divider valve; the fourth flow divider valve is connected into the rear-mounted water inlet path and is located behind the second water quality detection member in the preset water flowing direction; and the fourth flow divider valve is further connected to one end of the first backflow water path away from the water purification assembly.

To solve the above technical problems, another technical solution of the present disclosure is as follows: a control method of a mineralization water purifier, which is implemented using the waterway system for the mineralization water purifier according to claim 1, the control method including:
receiving a water quality control message; and
in response to the water quality control message, controlling the first flow divider valve to adjust a ratio of water flow between the alkaline water path and the purified water path.

Optionally, further including:
obtaining a total flow parameter from the first flow detection member, and determining whether the total flow parameter is greater than or equal to a first preset threshold;
in response to the total flow parameter being greater than or equal to the first preset threshold, controlling the first flow divider valve to adjust a flow rate of the purified water path to zero and adjust a flow rate of the alkaline water path to the maximum, and obtaining a water quality parameter from the first water quality detection member;
determining whether the water quality parameter is less than a second preset threshold; and
in response to the water quality parameter being less than the second preset threshold, generating a filter element replacement message, and transmitting the message by using a communication assembly.

To solve the above technical problems, another technical solution of the present disclosure is as follows: a mineralization water purifier, including:
the waterway system for the mineralization water purifier according to claim 1; and
a water outlet component, configured to discharge water to the outside, wherein the water outlet component is connected to the water outlet path of the waterway system for the mineralization water purifier.

Optionally, wherein the waterway system includes a rear-mounted water inlet path, a purified water path, and a water outlet path; the rear-mounted water inlet path is connected to the purified water path and the alkaline water path; one end of the purified water path away from the rear-mounted water inlet path and one end of the alkaline water path away from the rear-mounted water inlet path are both connected to the water outlet path.

Optionally, wherein the waterway system further includes a first flow divider valve; the first flow divider valve is connected to the rear-mounted water inlet path, the purified water path, and the alkaline water path.

Beneficial effects of the present disclosure are as follows: by simultaneous arrangement of the first alkaline filter material and the second alkaline filter material in the alkaline water path, first alkaline water flowing through the first alkaline filter material and second alkaline water flowing through the second alkaline filter material can be mixed, so as to make alkaline water having an appropriate alkalinity and meeting a usage demand by using the first alkaline water and the second alkaline water having an alkalinity different from that of the first alkaline water. This can reduce the possibility that final mineralized water of the waterway system for the mineralization water purifier has a high pH value can be reduced, and can improve the safety and stability of the waterway system for the mineralization water purifier.

Further, when the first alkaline filter material and the second alkaline filter material are arranged in the same filter material mounting cavity, during use of the waterway system used for the mineralization water purifier, the first alkaline filter material with higher alkalinity can inhibit the second alkaline filter material with lower alkalinity in the early stage of use. The strongly alkaline filter material releases an alkaline substance in the early stage and releases the alkaline substance together with the weakly alkaline filter material in the middle and later stages. The two filter materials can work together to greatly prolong the life of the filter element in the alkaline water path, thereby achieving a longer service life of the filter element.

### BRIEF DESCRIPTION OF THE DRAWINGS

To describe the technical solutions in the embodiments of the present disclosure more clearly, the following briefly describes the accompanying drawings required for describing the implementations. Apparently, the accompanying drawings in the following description show some implementations of the present disclosure, and a person of ordinary skill in the art can still derive other drawings from these accompanying drawings without creative efforts.

FIG. 1 is a diagram of change trends of pH values of water separately flowing through a first alkaline filter material and a second alkaline filter material;

FIG. 2 is a diagram of change trends of a pH value of water separately flowing through a first alkaline filter material, a pH value of water separately flowing through a second alkaline filter material, and a pH value of mixed water;

FIG. 3 is a schematic structural diagram of a waterway system for a mineralization water purifier according to an embodiment of the present disclosure;

FIG. 4 is a schematic structural diagram of a waterway system for a mineralization water purifier according to another embodiment of the present disclosure;

FIG. 5 is a diagram of change trends of a pH value of a waterway system for a mineralization water purifier according to yet another embodiment of the present disclosure;

FIG. 6 is a schematic structural diagram of a third flow divider valve according to an embodiment of the present disclosure;

FIG. 7 is a schematic structural diagram of a fourth flow divider valve according to another embodiment of the present disclosure;

FIG. 8 is a flowchart of a control method of a mineralization water purifier according to an embodiment; and

FIG. 9 is a flowchart of a control method of a mineralization water purifier according to another embodiment.

### DESCRIPTIONS OF REFERENCE NUMERALS

1: first alkaline filter material; 2: second alkaline filter material; 3: filter material mounting cavity; 41; rear-mounted water inlet path; 42: purified water path; 43: alkaline water path; 44: water outlet path; 45: second backflow water path; 46: second water drainage branch; 47: front-mounted water inlet path; 51: first flow divider valve; 52: backflow valve; 53: water inlet valve; 54: wastewater valve; 61: first water quality detection member; 62: first flow detection member; 63: second water quality detection member; 7: water purification assembly; and 8: pump body;
51a: first flow valve; 51b: second flow valve; 911: second flow divider valve; 912: first water drainage branch; 913: wastewater outlet; 921: first backflow water path; 922: third flow divider valve; 923: fourth flow divider valve 3.

### DETAILED DESCRIPTION OF THE EMBODIMENTS

In the present disclosure, the terms “arrange”, “mount”, and “connect” should be broadly understood. For example, it can be a fixed connection, a detachable connection, an integration, a mechanical connection, an electrical connection, direct connection, indirect connection through an intermediate medium, or internal communication between two devices, elements, or parts. Those of ordinary skill in the art can understand the specific meanings of the above terms in the present disclosure according to specific situations.

Orientations or positional relationships indicated by “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, and the like are orientations or positional relationships as shown in the drawings, and are only for the purpose of facilitating and simplifying the descriptions of the present disclosure instead of indicating or implying that devices or elements indicated must have particular orientations, and be constructed and operated in the particular orientations, so that these terms are not construed as limiting the present disclosure.

In addition, the terms “first” and “second” are used for descriptive purposes only and are not to be construed as indicating or implying relative importance or to implicitly indicate the number of technical features indicated. From this, features defined as “first” and “second” can explicitly or implicitly include at least one feature. In the description of the present disclosure, “plurality” means at least two, such as two and three unless it is specifically defined otherwise.

Furthermore, in addition to being used for representing orientations or positional relationships, some of the above terms can be further used for representing other meanings, such as the term “upper” being used in some cases to represent attachment or connection relationships. Those of ordinary skill in the art can understand the specific meanings of these terms in the present disclosure according to specific situations.

In order to make the objectives, technical solutions, and advantages of the present disclosure clearer, the following is a further detailed explanation of the present disclosure in conjunction with the accompanying drawings and embodiments. It should be understood that the specific embodiments described herein are merely used to explain the present disclosure but are not intended to limit the present disclosure.

With the improvement of productivity, people have increasingly high demands for the quality of life and convenience. Alkaline water is a kind of water with a pH value greater than 7. Drinking alkaline water in moderation can replenish water, improve microcirculation, and promote metabolism. Meanwhile, in a case of water and electrolyte disturbance, the alkaline water further has an improvement function. For example, drinking alkaline water can help replenish water after a person vomits heavily. In addition, the alkaline water can further help neutralize excessive stomach acid, protect the gastric mucosa, and reduce the possibility of a peptic ulcer. Therefore, mineralized water is widely favored by people as drinking water. Meanwhile, there is also a requirement for the alkaline water during production and experimentation.

At present, there are two common methods to prepare alkaline water. The first method is to manually mix an alkaline substance with water to form alkaline water with a suitable pH value. However, this method is very complicated, has a chemical knowledge threshold, and is inefficient. The second method is to add an alkaline filter material into a container with water, such as a water dispenser and a water purifier. Alkaline substances in the alkaline filter material can be dissolved into the water in the container, thereby changing the water into alkaline water. In the early stage of use, a large number of alkaline substances enter the water, causing the pH value of the alkaline water to easily become large during this period. In the later stage of use, the content of the alkaline substances in the alkaline filter material decreases. As a result, a small number of the alkaline substances enter the water, and the pH value of the alkaline water within this period of time is too low. The alkaline water with a low or high pH value cannot meet a water utilization demand, which greatly affects the usability of the alkaline filter material.

To improve or solve the above technical problems, inventors of the present disclosure have conducted long-term research and proposed at least following embodiments.

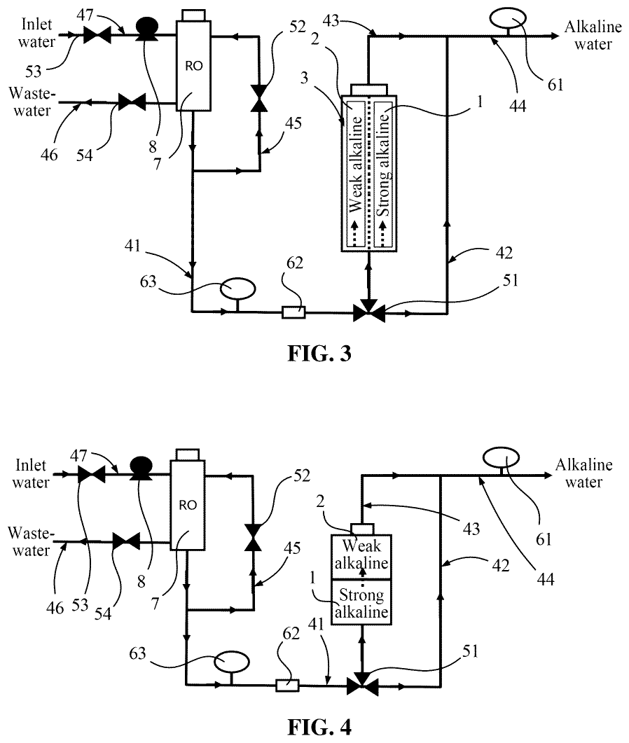

Referring to FIG. 3 and FIG. 4, FIG. 3 is a schematic structural diagram of a waterway system for a mineralization water purifier according to an embodiment of the present disclosure. FIG. 4 is a schematic structural diagram of a waterway system for a mineralization water purifier according to another embodiment of the present disclosure. A specific implementation of the present disclosure provides a waterway system for a mineralization water purifier, to output alkaline water.

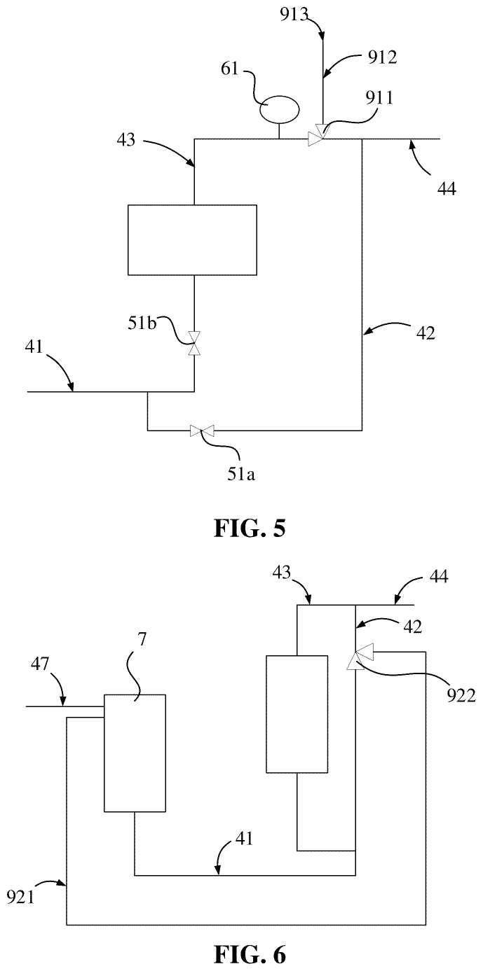

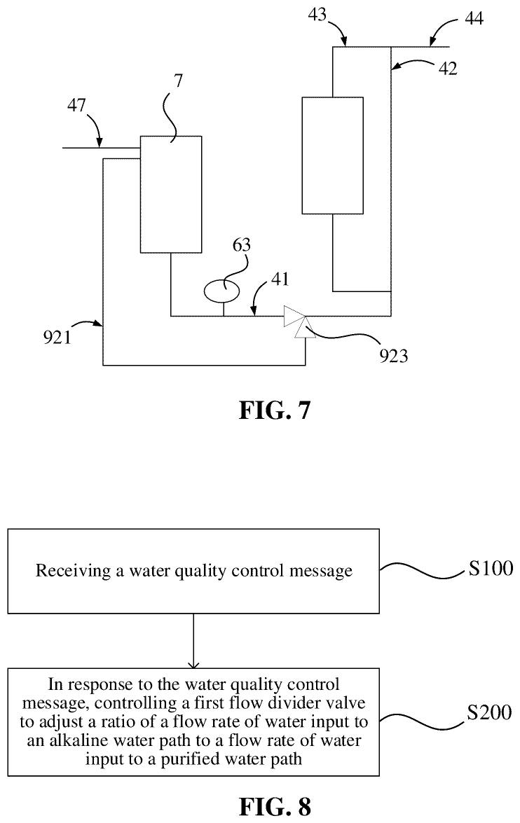

Refer to FIG. 5 to FIG. 7 together, the waterway system used for a mineralization water purifier can include a first alkaline filter material 1, a second alkaline filter material 2, and an alkaline water path 43. An alkalinity of the first alkaline filter material 1 is greater than an alkalinity of the second alkaline filter material 2, and the first alkaline filter material 1 can be configured to inhibit the second alkaline filter material 2 from releasing an alkaline substance.

In the alkaline water path 43, the first alkaline filter material 1 and the second alkaline filter material 2 can be sequentially arranged in a preset water flowing direction. Alternatively, the alkaline water path 43 can be provided with a filter material mounting cavity 3 configured to simultaneously accommodate the first alkaline filter material 1 and the second alkaline filter material 2.

In the structure provided by this specific implementation, by simultaneous arrangement of the first alkaline filter material 1 and the second alkaline filter material 2 in the alkaline water path 43, first alkaline water flowing through the first alkaline filter material 1 and second alkaline water flowing through the second alkaline filter material 2 can be mixed, so as to make alkaline water having an appropriate alkalinity and meeting a usage demand by using the first alkaline water and the second alkaline water having an alkalinity different from that of the first alkaline water. This can reduce the possibility that final mineralized water of the waterway system for the mineralization water purifier has a high pH value, and can improve the safety and stability of the waterway system for the mineralization water purifier.

Further, when the first alkaline filter material 1 and the second alkaline filter material 2 are arranged in the same filter material mounting cavity 3, during use of the waterway system for the mineralization water purifier, the first alkaline filter material 1 with higher alkalinity can inhibit the second alkaline filter material 2 with lower alkalinity in the early stage of use. The strongly alkaline filter material releases an alkaline substance in the early stage and releases the alkaline substance together with the weakly alkaline filter material in the middle and later stages. The two filter materials can work together to greatly prolong the life of the filter element in the alkaline water path 43, thereby achieving a longer service life of the filter element.

In a specific application, the second alkaline filter material 2 can be a weakly alkaline filter material, and the first alkaline filter material 1 can be a strongly alkaline filter material. The alkalinities of the weakly alkaline filter material and the strongly alkaline filter material can be a relative concept, namely, the alkalinity of the first alkaline filter material 1 is greater than the alkalinity of the second alkaline filter material 2. The alkaline substances released by the first alkaline filter material 1 and the second alkaline filter material 2 can include hydroxide ions OH and bicarbonate ions HCO₃⁻.

The strongly alkaline filter material can be made of a strongly alkaline material, such as at least one of brucite, periclase, sepiolite, and magnesite. The brucite is taken as an example. The brucite contains Mg (OH)₂, so that the brucite can undergo reaction A in water, thereby releasing (dissolving out) OH− and enhancing the alkalinity of the water, thereby increasing the pH value of the water to obtain alkaline water.

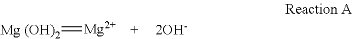

The weakly alkaline filter material can be made of a weakly alkaline material, such as at least one of calcite, dolomite, stalactite, limestone, and aragonite. The calcite is taken as an example. The calcite contains CaCO₃. When soaked in water, the calcite can first undergo reaction B to realize CO₃²⁻ in the water. Then, CO₃²⁻ can be hydrolyzed with H₂O to form OH⁻.

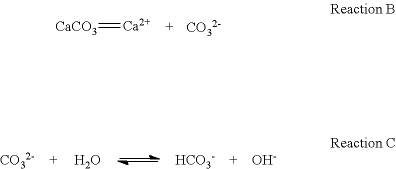

From this, it can be found that OH⁻ can be obtained from the strongly alkaline filter material only by one step, but OH⁻ is obtained from the weakly alkaline filter material by two steps. Moreover, the rate of reaction C is much less than that of reaction A, so the strongly alkaline material can preferentially dissolve out OH⁻ into the water. Moreover, reaction C is a reversible reaction. When reaction A occurs preferentially, the chemical equilibrium of reaction C shifts to the left. Therefore, the strongly alkaline filter material can inhibit the release of OH⁻ from the weakly alkaline filter material.

As shown in FIG. 3, the strongly alkaline filter material is combined with the weakly alkaline filter material to form a parallel structure, and the fluid in the alkaline water path 43 flows through both the strongly alkaline filter material and the weakly alkaline filter material simultaneously. Further, the strongly alkaline filter material and the weakly alkaline filter material can be separately arranged in two filter elements, or assembled into the same filter element. When the strongly alkaline filter material and the weakly alkaline filter material are located in the same filter element, by using the inhibitory effect of the strongly alkaline filter material on the weakly alkaline filter material, throughout the service life of the filter element, the strongly alkaline filter material releases OH⁻ in the early stage and releases OH⁻ together with the weakly alkaline filter material in the middle and late stages. The two filter materials can work together to greatly prolong the life of the filter element in the alkaline water path 43, thereby achieving a longer service life of the filter element.

As shown in FIG. 4, the strongly alkaline filter material is combined with the weakly alkaline filter material to form an axially integrated structure, and the fluid in the alkaline water path 43 flows first through the strongly alkaline filter material and then through the weakly alkaline filter material. Further, the strongly alkaline filter material and the weakly alkaline filter material can be separately arranged in two filter elements, or assembled into the same filter element. When the strongly alkaline filter material and the weakly alkaline filter material are located in the same filter element, by using the inhibitory effect of the strongly alkaline filter material on the weakly alkaline filter material, throughout the service life of the filter element, the strongly alkaline filter material releases OH⁻ in the early stage and releases OH⁻ together with the weakly alkaline filter material in the middle and late stages. The two filter materials can work together to greatly prolong the life of the filter element in the alkaline water path 43, thereby achieving a longer service life of the filter element.

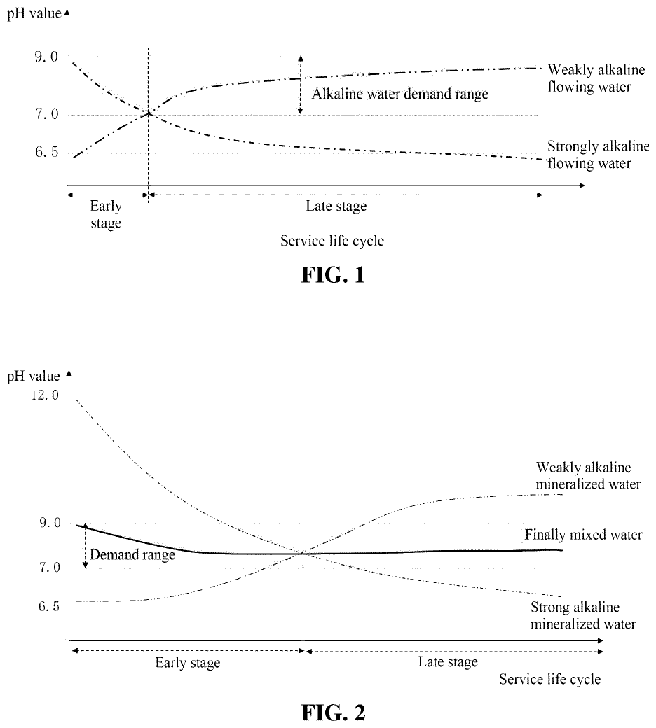

Referring to FIG. 1 and FIG. 2, FIG. 1 is a diagram of change trends of pH values of water separately flowing through a first alkaline filter material and a second alkaline filter material. Referring to FIG. 2, FIG. 2 is a diagram of change trends of a pH value of water separately flowing through a first alkaline filter material, a pH value of water separately flowing through a second alkaline filter material, and a pH value of mixed water. Multiple embodiments are obtained by adjusting the mass ratio of the strongly alkaline filter material to the weakly alkaline filter material below. The pH values of the water are tested at different flow rates in each embodiment, and Table 1 is obtained as follows. An adjustment range for the mass ratio of the strongly alkaline filter material is 10% to 50%, and correspondingly, an adjustment range for the mass ratio of the weakly alkaline filter material is 50% to 90%.

TABLE 1

| Percentage | | | | | |
|---|---|---|---|---|---|
| of strongly | pH values of water at different water flow rates | | | | |
| alkaline material | 0 L | 2000 L | 4000 L | 6000 L | 7200 L |
| 0% | 6.58 | 6.92 | 7.33 | 7.23 | 7.20 |
| 5% | 6.96 | 7.25 | 7.32 | 7.27 | 7.20 |
| 10% | 7.01 | 7.06 | 7.16 | 7.15 | 7.07 |
| 20% | 7.45 | 7.43 | 7.38 | 7.25 | 7.19 |
| 30% | 7.86 | 7.74 | 7.42 | 7.28 | 7.15 |
| 40% | 8.25 | 8.02 | 7.74 | 7.33 | 7.17 |
| 50% | 8.89 | 8.61 | 8.10 | 7.52 | 7.23 |
| 60% | 9.15 | 8.87 | 8.46 | 7.88 | 7.21 |
| 100% | 10.12 | 8.55 | 7.41 | 6.77 | 6.49 |

Based on Table 1, in combination with FIG. 1 and FIG. 2 for analysis, when the percentage of the strongly alkaline filter material is 0%, it indicates that there is only the weakly alkaline filter material. Since the weakly alkaline filter material itself has low dissolution speed and poor ability to alkalize water, the pH value of produced water is less than 7 when the first 2000 L of water flows through, and alkaline water that meets a water utilization demand cannot be obtained in the early stage. Subsequently, as the volume of flowing water increases, pores inside the weakly alkaline material gradually become interconnected under the impact of the water. The water can not only pass through a surface of the material, but also pass through the inside of the material, thereby enlarging a contact area between water molecules and a mineralization material and improving the reaction rate, so that the pH value of the flowing water gradually increases to 7 or above.

When the percentage of the strongly alkaline filter material increases to 5%, the pH value at 0 L increases. This is because 5% of the strongly alkaline filter material is added, which releases, at the beginning stage, OH⁻ into the flowing water. When the percentage of the strongly alkaline filter material is between 10% and 50%, the pH value can be maintained between 7.0 and 9.0 throughout the entire lifespan, thus obtaining alkaline water that meets the water utilization demand.

When the percentage of the strongly alkaline filter material reaches 60%, the pH value at the beginning stage reaches 9.15, which exceeds the range of weakly alkaline water and does not meet the water utilization demand. When the percentage of the strongly alkaline filter material is 100%, the pH value at the beginning stage reaches 10.12, which greatly exceeds 9 which is an upper limit value and decays quickly. When the volume of flowing water reaches 6000 L, the pH value is already less than 7. This is because the strongly alkaline material has a high ability to release OH− into the flowing water. However, since OH− is dissolved out quickly, the alkaline substance contained in the strongly alkaline filter material is consumed quickly, which weakens the ability of the filter element to produce alkaline water in the later stage of use.

It should be noted that in FIG. 1 and FIG. 2, different first alkaline filter materials 1 and different second alkaline filter material 2 can be used to be combined, or the flow rate and/or flow velocity of the flowing water can be different. Alkalinities of alkaline substances dissolved into the water by the different first alkaline filter materials 1 cannot be the same. Alkalinities of alkaline substances dissolved into the water by the different second alkaline filter materials 2 cannot necessarily be the same. Amounts of alkaline substances contained in flowing water with different flow rates and/or flow velocities can not necessarily be the same.

Due to various reasons, the pH value presented in the curve that represents strongly alkaline flowing water in FIG. 1 in the service life cycle is different from the pH value presented in the curve that represents strongly alkaline mineralized water in FIG. 2 in the service life cycle. However, it is not difficult to see that the curves in FIG. 1 and FIG. 2 have similar change trends, and the same is true for the weakly alkaline flowing water and the weakly alkaline mineralized water.

Therefore, although the specific values are different, the combination of the first alkaline filter material 1 and the second alkaline filter material 2 can have similar effects on the pH value of the alkaline water output from the waterway system.

Optionally, as shown in FIG. 3 and FIG. 4, the waterway system can further include a second backflow water path 45, a second water drainage branch 46, a front-mounted water inlet path 47, a return valve 52, a water inlet valve 53, a wastewater valve 54, and a pump body 8. One end of the second backflow water path 45 is connected to the rear-mounted water inlet path 41, and the other end of the second backflow water path 45 is connected to an input end of the water purification assembly 7, and the return valve 52 is connected into the second backflow water path 45. The pre-mounted water inlet path 47 is connected to an external water source and the input end of the water purification assembly 7. The pump body 8 and the water inlet valve 53 are connected to the pre-mounted water inlet path 47, and water in the entire waterway system can flow under the driving of the pump body 8. The second water drainage branch 46 is connected to a wastewater outlet 913 of the water purification assembly 7, and is configured to discharge wastewater generated during a filtration and purification process of the water purification assembly 7 to the outside. The wastewater valve 54 is connected to the water drainage branch.

In a specific implementation of the present disclosure, the waterway system can include a rear-mounted water inlet path 41, a purified water path 42, and a water outlet path 44. The rear-mounted water inlet path 41 is connected to the purified water path 42 and the alkaline water path 43. One end of the purified water path 42 away from the rear-mounted water inlet path 41 and one end of the alkaline water path 43 away from the rear-mounted water inlet path 41 are both connected to the water outlet path 44.

In the structure provided in this specific implementation, purified water output from the purified water path 42 and the alkaline water output from the alkaline water path 43 can be mixed and then output through the water outlet path 44, thereby further mixing the alkaline water. This can reduce the probability that final mineralized water of the waterway system for the mineralization water purifier has a high pH value, and can improve the safety and stability of the waterway system for the mineralization water purifier.

In a specific embodiment provided in the present disclosure, the waterway system can further include a first flow divider valve 51. The first flow divider valve 51 is connected to the rear-mounted water inlet path 41, the purified water path 42, and the alkaline water path 43.

In the structure provided in this specific implementation, the first flow divider valve 51 can control the volume of water respectively input into the purified water path 42 and the alkaline water path 43 through the rear-mounted water inlet path 41, and then control a ratio of alkaline water to purified water when the water outlet path 44 outputs water to the outside, thereby further mixing the alkaline water. This can reduce the probability that final mineralized water of the waterway system for the mineralization water purifier has a high pH value, and can improve the safety and stability of the waterway system for the mineralization water purifier.

In the structure provided in this specific implementation, the waterway system further includes a first flow valve 51a and a second flow valve 51b; the first flow valve 51a is connected to the purified water path 42; and the second flow valve 51b is connected to the alkaline water path 43.

Through the structure provided in this specific implementation, opening and closing of the first flow valve 51a and opening and closing of the second flow valve 51b can be controlled, thereby controlling a flow rate and flow velocity of the alkaline water flowing out of the alkaline water path 43 and a flow rate and flow velocity of the purified water flowing out of the purified water path 42, controlling a ratio of the alkaline water flowing into the water outlet path 44 to the purified water flowing into the water outlet path 44, and further mixing the alkaline water. This can improve the safety and stability of the waterway system for the mineralization water purifier.

In the structure provided in this specific implementation, the waterway system further includes a first water quality detection member 61 and a controller; and both the first water quality detection member 61 and the first flow divider valve 51 are connected to the controller. The first water quality detection member 61 is arranged at the alkaline water path 43, and is located behind the first alkaline filter material 1 and the second alkaline filter material 2 in the preset water flowing direction.

Optionally, the first water quality detection member 61 can also be arranged in the water outlet path 44.

In the structure provided in this specific implementation, the first water quality detection member 61 is arranged in the water outlet path 44 to visually represent final water quality of the mineralized water. The first water quality detection member 61 is arranged in the alkaline water path 43 to test the water quality of the alkaline water. Through the water quality of the alkaline water, a ratio of the alkaline water and the purified water required to adjust the mineralized water quality to a specified pH range can be calculated.

Therefore, by the arrangement of the first water quality detection member 61, the water quality of the water in the waterway system can be effectively monitored, and then the controller can control at least one of the valve bodies such as the first flow divider valve 51, the first flow valve 51a, and the second flow valve 51b according to feedback from the water quality. This can improve the accuracy of the waterway system for controlling the alkalinity of the alkaline water, making the waterway system to output water that better meets a user need, and improving the usability of the waterway system.

In a specific implementation provided in the present disclosure, the waterway system can further include a first flow detection member 62. The first flow detection member 62 is arranged in at least one of the rear-mounted water inlet path 41, the alkaline water path 43, and the purified water path 42, and the first flow detection member 62 is connected to the controller. The first flow detection member 62 can monitor the water volume of the alkaline water path 43 and even the water volume of the entire waterway system, thereby monitoring the service life of the waterway system. In conjunction with the first water quality detection member 61, working effects of the waterway system at different using stages can be effectively monitored, thereby improving the usability of the waterway system.

In a specific implementation provided in the present disclosure, the first water quality detection member 61 is arranged in the alkaline water path 43, and is located behind the first alkaline filter material 1 and the second alkaline filter material 2 in the preset water flow direction. The waterway system further includes a second flow divider valve 911. The second flow divider valve 911 is connected to the controller. The second flow divider valve 911 is connected to the alkaline water path 43 and is located behind the first water quality detection member 61 in the preset water flow direction. The waterway system is further provided with a first water drainage branch 912 and a wastewater outlet 913. One end of the first water drainage branch 912 is connected to the second flow divider valve 911, and the other end of the first water drainage branch 912 is connected to the wastewater outlet 913.

In the structure provided in this specific implementation, the first water drainage branch 912 can be used in conjunction with the second flow divider valve 911 to input a portion of water that meets the a usage demand in the alkaline water path 43 to the water outlet path 44, and to discharge a portion of water that does not meet the usage demand to the outside, thereby reducing the problems such as excessive water being discharged from the water outlet path 44, a pH value exceeding the standard, and a pH value being low, and improving the usability of the waterway system.

In a specific implementation provided in the present disclosure, the waterway system can further include a second water quality detection member 63 and a water purification assembly 7. An output end of the water purification assembly 7 is connected to one end of the rear-mounted water inlet path 41 away from the first flow divider valve 51. The second water quality detection member 63 is arranged in the rear-mounted water inlet path 41. The second water quality detection member 63 is connected to the controller. Each of the first water quality detection member 61 and the second water quality detection member 63 includes at least one of a TDS value detection member and a pH value detection member.

In the structure provided in this specific implementation, the second water quality detection member 63 can detect the water input by the water purification assembly 7 to the rear-mounted water inlet path 41, thereby monitoring the water before the water is input to the alkaline water path 43, to achieve the prediction and calculation of the pH value of the alkaline water from the water outlet path 44. This can improve the usability of the waterway system.

A pH value detection member is configured to detect a concentration of hydrogen ions in a measured substance and can convert the concentration into a corresponding usable output signal, thereby representing the pH value of the water. A TDS value detection member is equipment configured to measure total dissolved solids (TDS) in water, which can continuously monitor a conductivity value of a measured substance. The pH value of the measured substance can be calculated according to the conductivity value, thus representing the pH value of the water.

In a specific implementation provided in the present disclosure, the waterway system can be further provided with a first backflow water path 921. The first backflow water path 921 is connected to the water purification assembly 7. The waterway system further includes a third flow divider valve 922. The third flow divider valve 922 is connected to the purified water path 42 and one end of the first backflow water path 921 away from the water purification assembly 7.

Optionally, the waterway system further includes a fourth flow divider valve 923; the fourth flow divider valve 923 is connected into the rear-mounted water inlet path 41 and is located behind the second water quality detection member 63 in the preset water flowing direction; and the fourth flow divider valve 923 is further connected to one end of the first backflow water path 921 away from the water purification assembly 7.

In the structure provided in this specific implementation, the first backflow water path 921 can be configured to return the water in the purified water path 42 to the water purification assembly 7, thereby reducing the probability of a low pH value of the alkaline water caused by excessive purified water and avoiding a waste of the purified water. Meanwhile, the first backflow water path 921 can further convey purified water that does not meet a usage standard back to the water purification assembly 7 for further filtration, to reduce the probability that the water in the water outlet path 44 is unqualified.

In a specific implementation provided in the present disclosure, the waterway system can further include a communication assembly. The communication assembly is connected to the controller. The communication assembly can be configured to receive a water quality control message, and the controller can control the waterway system according to the water quality control message, thereby outputting, through the water outlet path 44, water that comply with the water quality control message.

A specific implementation of the present disclosure further provides a mineralization water purifier, including a water outlet component and the waterway system for the mineralization water purifier according to any one of the above specific implementations. The water outlet component is configured to discharge water to the outside, and the water outlet component is connected to the water outlet path 44 of the waterway system for the mineralization water purifier.

In the structure provided by this specific implementation, by simultaneous arrangement of the first alkaline filter material 1 and the second alkaline filter material 2 in the alkaline water path 43, first alkaline water flowing through the first alkaline filter material 1 and second alkaline water flowing through the second alkaline filter material 2 can be mixed, so as to make alkaline water having an appropriate alkalinity and meeting a usage demand by using the first alkaline water and the second alkaline water having an alkalinity different from that of the first alkaline water. This can reduce the possibility that final mineralized water of the waterway system for the mineralization water purifier has a high pH value, and can improve the safety and stability of the waterway system for the mineralization water purifier.

Further, when the first alkaline filter material 1 and the second alkaline filter material 2 are arranged in the same filter material mounting cavity 3, during use of the waterway system used for the mineralization water purifier, the first alkaline filter material 1 with higher alkalinity can inhibit the second alkaline filter material 2 with lower alkalinity in the early stage of use. The strongly alkaline filter material releases an alkaline substance in the early stage and releases the alkaline substance together with the weakly alkaline filter material in the middle and later stages. The two filter materials can work together to greatly prolong the life of the filter element in the alkaline water path 43, thereby achieving a longer service life of the filter element.

A specific implementation of the present disclosure can further provide a control method of a mineralization water purifier. Referring to FIG. 8, FIG. 8 is a flowchart of a control method of a mineralization water purifier according to an embodiment. It should be noted that if there are substantially identical results, this implementation is not limited to a step order shown in FIG. 8. As shown in FIG. 8, the control method of the mineralization water purifier can include:

S100: Receiving a water quality control message.

S200: In response to the water quality control message, controlling the first flow divider valve 51 to adjust a ratio of water flow between the alkaline water path 43 and the purified water path 42.

An executive body of the control method of the mineralization water purifier provided in the present disclosure can be a controller for a waterway system for a mineralization water purifier. The controller is connected to the first flow divider valve 51 and can receive the water quality control message, thereby controlling the water quality of the water output from the water outlet path 44 by adjusting the ratio of the flow rate of the water input to the alkaline water path 43 to the flow rate of the water input to the purified water path 42.

The water quality control message can be generated locally in the mineralization water purifier. For example, according to the case of operating the mineralization water purifier, a user inputs an instruction to generate a corresponding water quality control message. The water quality control message can also be generated on a client. The client is connected to the mineralization water purifier through a communication assembly. The communication assembly receives the water quality control message generated and sent by the client, and transmits the water quality control message to the controller.

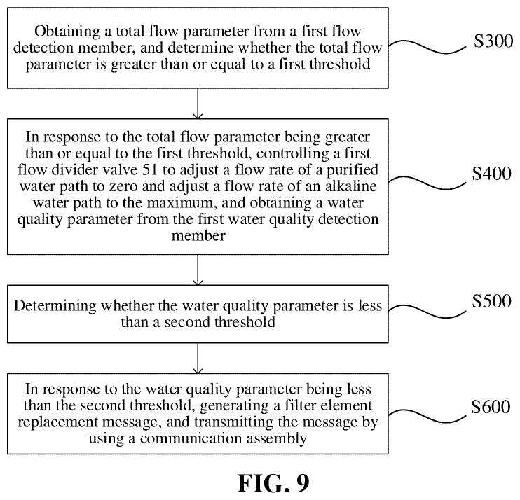

Referring to FIG. 9, FIG. 9 is a flowchart of a control method of a mineralization water purifier according to another embodiment. It should be noted that if there are substantially identical results, this implementation is not limited to a step order shown in FIG. 9. As shown in FIG. 9, the control method of the mineralization water purifier can further include:

S300: Obtaining a total flow parameter from the first flow detection member 62, and determine whether the total flow parameter is greater than or equal to a first preset threshold.

S400: In response to the total flow parameter being greater than or equal to the first preset threshold, controlling the first flow divider valve 51 to adjust a flow rate of the purified water path 42 to zero and adjust a flow rate of the alkaline water path 43 to the maximum, and obtain a water quality parameter from the first water quality detection member 61.

S500: Determining whether the water quality parameter is less than a second preset threshold.

S600: In response to the water quality parameter being less than the second preset threshold, generating a filter element replacement message, and transmitting the message by using the communication assembly.

Through the method provided in this specific implementation, the total flow parameter measured by the first flow detection member 62 can be used to monitor the service life of the waterway system. Furthermore, when the total flow parameter is greater than or equal to the first preset threshold, the waterway system is promptly adjusted to only discharge water from the alkaline water path 43, so that the water quality parameter can be used to determine whether the alkaline filter element can still work normally to prepare alkaline water. When the alkaline filter element cannot work normally, the filter element replacement message is used to notify a user of replacement. This greatly improves the usability of the mineralization water purifier.

Reference to “an embodiment” and “implementation” in the present disclosure means that a particular feature, structure or characteristic described in conjunction with an embodiment can be included in at least one embodiment of the present disclosure. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described herein can be combined with other embodiments. In addition, it should be further understood that provided that there is no contradiction between the features, structures or characteristics described in the various embodiments of the present disclosure, the features, structures, or characteristics can be arbitrarily combined to form another embodiment that does not depart from the spirit and scope of the technical solutions of the present disclosure.

Finally, it should be noted that the above implementations are only configured to explain the technical solutions of the present disclosure and not intended to limit the technical solutions. Although the present disclosure has been described in detail with reference to the preferred implementations, those of ordinary skill in the art should understand that the technical solutions of the present disclosure can be modified or equivalently replaced without departing from the spirit and scope of the technical solutions of the present disclosure.

What is claimed is:

1. A waterway system for a mineralization water purifier, comprising a first alkaline filter material, a second alkaline filter material, and an alkaline water path, wherein an alkalinity of the first alkaline filter material is greater than an alkalinity of the second alkaline filter material; and the first alkaline filter material is configured to inhibit the second alkaline filter material from releasing an alkaline substance,
wherein in the alkaline water path, the first alkaline filter material and the second alkaline filter material are sequentially arranged in a preset water flowing direction, and/or, the alkaline water path is provided with a filter material mounting cavity configured to simultaneously accommodate the first alkaline filter material and the second alkaline filter material.

2. The waterway system for the mineralization water purifier according to claim 1, wherein the waterway system comprises a rear-mounted water inlet path, a purified water path, and a water outlet path; the rear-mounted water inlet path is connected to the purified water path and the alkaline water path; and one end of the purified water path away from the rear-mounted water inlet path and one end of the alkaline water path away from the rear-mounted water inlet path are both connected to the water outlet path.

3. The waterway system for the mineralization water purifier according to claim 2, wherein the waterway system further comprises a first flow divider valve; the first flow divider valve is connected to the rear-mounted water inlet path, the purified water path, and the alkaline water path.

4. The waterway system for the mineralization water purifier according to claim 3, wherein the waterway system further comprises a first flow valve and a second flow valve; the first flow valve is connected to the purified water path; and the second flow valve is connected to the alkaline water path.

5. The waterway system for the mineralization water purifier according to claim 4, wherein the waterway system further comprises a first water quality detection member and a controller; both the first water quality detection member and the first flow divider valve are connected to the controller.

6. The waterway system for the mineralization water purifier according to claim 5, wherein the first water quality detection member is arranged at the water outlet path.

7. The waterway system for the mineralization water purifier according to claim 5, wherein the first water quality detection member is arranged at the alkaline water path, and is located behind the first alkaline filter material and the second alkaline filter material in the preset water flowing direction.

8. The waterway system for the mineralization water purifier according to claim 7, wherein the waterway system further comprises a first flow detection member; the first flow detection member is arranged on at least one of the rear-mounted water inlet paths, the alkaline water path, and the purified water path; and the first flow detection member is connected to the controller.

9. The waterway system for the mineralization water purifier according to claim 8, the waterway system further comprises a second flow divider valve; the second flow divider valve is connected to the controller; and the second flow divider valve is connected into the alkaline water path and is located behind the first water quality detection member in the preset water flowing direction.

10. The waterway system for the mineralization water purifier according to claim 9, wherein a first water drainage branch and a wastewater outlet are further arranged in the waterway system; one end of the first water drainage branch is connected to the second flow divider valve; and the other end of the first water drainage branch is connected to the wastewater outlet.

11. The waterway system for the mineralization water purifier according to claim 3, wherein the waterway system further comprises a second water quality detection member and a water purification assembly; an output end of the water purification assembly is connected to one end of the rear-mounted water inlet path away from the first flow divider valve; and the second water quality detection member is arranged in the rear-mounted water inlet path; and the second water quality detection member is connected to the controller.

12. The waterway system for the mineralization water purifier according to claim 11, wherein the first water quality detection member and the second water quality detection member are at least one of a Total Dissolved Solids (TDS) value detection member and a pH value detection member.

13. The waterway system for the mineralization water purifier according to claim 12, wherein a first backflow water path; the first backflow water path is connected to the water purification assembly.

14. The waterway system for the mineralization water purifier according to claim 13, wherein the waterway system further comprises a third flow divider valve; the third flow divider valve is connected to the purified water path and one end of the first backflow water path away from the water purification assembly.

15. The waterway system for the mineralization water purifier according to claim 14, wherein the waterway system further comprises a fourth flow divider valve; the fourth flow divider valve is connected into the rear-mounted water inlet path and is located behind the second water quality detection member in the preset water flowing direction; and the fourth flow divider valve is further connected to one end of the first backflow water path away from the water purification assembly.

16. A control method of a mineralization water purifier, which is implemented using the waterway system for the mineralization water purifier according to claim 1, the control method comprising:
receiving a water quality control message; and
in response to the water quality control message, controlling the first flow divider valve to adjust a ratio of water flow between the alkaline water path and the purified water path.

17. The control method of the mineralization water purifier according to claim 16, comprising:
obtaining a total flow parameter from the first flow detection member, and determining whether the total flow parameter is greater than or equal to a first preset threshold;
in response to the total flow parameter being greater than or equal to the first preset threshold, controlling the first flow divider valve to adjust a flow rate of the purified water path to zero and adjust a flow rate of the alkaline water path to the maximum, and obtaining a water quality parameter from the first water quality detection member;
determining whether the water quality parameter is less than a second preset threshold; and
in response to the water quality parameter being less than the second preset threshold, generating a filter element replacement message, and transmitting the message by using a communication assembly.

18. A mineralization water purifier, comprising:
the waterway system for the mineralization water purifier according to claim 1; and
a water outlet component, configured to discharge water to the outside, wherein the water outlet component is connected to the water outlet path of the waterway system for the mineralization water purifier.

19. The mineralization water purifier according to claim 18, wherein the waterway system comprises a rear-mounted water inlet path, a purified water path, and a water outlet path; the rear-mounted water inlet path is connected to the purified water path and the alkaline water path; one end of the purified water path away from the rear-mounted water inlet path and one end of the alkaline water path away from the rear-mounted water inlet path are both connected to the water outlet path.

20. The mineralization water purifier according to claim 19, wherein the waterway system further comprises a first flow divider valve; the first flow divider valve is connected to the rear-mounted water inlet path, the purified water path, and the alkaline water path.
